(19) United States
(12) Patent Application Publication
(10) Pub. No.: US 2008/0076474 A1
(43) Pub. Date: Mar. 27, 2008

(54) Laminated card assembly

(75) Inventor: Chun-Hsin Ho, Taipei (TW)

Correspondence Address: BACON & THOMAS, PLLC, 625 SLATERS LANE, FOURTH FLOOR, ALEXANDRIA, VA, 22314, US

(73) Assignee: Taisys Technologies Co., Ltd., Taipei (TW)

(21) Appl. No.: 11/524,194

(22) Filed: Sep. 21, 2006

(51) Int. Cl. H04B 1/38; H04M 1/00

(52) U.S. Cl. 455/558

(57) ABSTRACT

A laminated card assembly is disclosed. The laminated card assembly for use with a communication terminal includes a transaction card having a first engagement mechanism and being shaped into a standard SIM card; and a flexible SIM sheet, for performing communication operation for the communication terminal, having a second engagement mechanism to engage with the first engagement mechanism of the transaction card. Therefore, the flexible SIM sheet can be laminated on the transaction card to be inserted into a standard SIM socket of the communication terminal, thereby facilitating to integrate multiple applications.

### FIELD OF THE INVENTION

The present invention relates to an integrated card system, and more particularly, to a laminated card assembly for use with a communication terminal, i.e., a mobile phone.

### BACKGROUND OF THE INVENTION

Generally, there are many types of telecommunication networks, which have been established for providing a variety of services to network subscribers. Certainly, the widely used and well-known service provided by the telecommunication networks is mobile phone services, such as with cellular telephones. Meanwhile, several surface contacting cards with special circuits are widely used in electronic devices to enhance the functions of the electronic devices for providing more services. For example, a subscriber identity module (SIM) card could be placed in a portable phone to dedicate the phone's functions to the SIM card owner. Furthermore, some telecommunication networks provide other services that involve banking operations and transaction functions. However, the compact SIM card merely includes basic information of owner for providing a variety of services to network subscribers. When services of banking operations and transaction functions are provided, there should be a lot of data transmission between telecommunication networks, because the compact SIM in the portable phone could not provide further information.

Moreover, IC cards are used in numerous applications such as payment at a point of sale (known as “bank cards”), public telephones, payment for parking, payment for tolls, mobile telephones (e.g., SIM cards), public transportation, or electronic purse. Each of these applications is associated with a specific card: a bank card, a phone card, a parking card, a SIM card for GSM telephony, and so on.

In practice, the problems ensuing from stolen and forged credit cards and cash cards are becoming more and more serious, and increased efforts are being made to reduce the risks involved in this respect. Many solutions have been proposed, including time limits, limited withdrawals, duplicate encryption, and the identification of the card owner with all manner of means ranging from PIN codes to fingerprints, one-time passwords, etc. Regardless of the solutions applied, a fraudulent person is able to pass through the different barriers and obstacles with the aid of ever more sophisticated methods.

Furthermore, the use of mobile telephones or electronic wallets has also been discussed as a means of payment, and an increasing number of payments in greater sums will at times be made in electronic cash. False/cloned telephones and SIM cards already exist, and the use of telephones and SIM cards in respect of payments will increase the above-identified risks still more.

One of the problems encountered in daily use of such a variety of cards lies in that one of the cards might not be available when it is to be used, no matter whether it is left at home, its credit has been run out, or it has expired. In addition, administration and carry of various cards is inconvenient. Therefore, there is a strong need for the so-called “multi-application cards”.

Although some multi-application cards are technically feasible, in practice they are very difficult to implement. Meanwhile, the prior art fails to introduce a SIM card combined with a bank card for integrating multiple applications. Therefore, it needs to provide an integrated subscriber identification module (SIM) card system for use with a communication terminal, which introduces a dual card system for use with a communication terminal for facilitating to integrating multiple applications, and can rectify those drawbacks of the prior art and solve the above problems.

### SUMMARY OF THE INVENTION

This paragraph extracts and compiles some features of the present invention; other features will be disclosed in the follow-up paragraph. It is intended to cover various modifications and similar arrangements included within the spirit and scope of the appended claims, and this paragraph also is considered to refer.

Accordingly, the prior art is limited by the above problems. It is an object of the present invention to provide a laminated card assembly integrated subscriber identification module (SIM) card for use with a mobile phone, which introduce a dual card system for use with a communication terminal and a communication terminal for facilitating to integrating multiple applications, more particularly, combining a multi-application card and a SIM card of mobile phone to integrate multiple applications.

In accordance with an aspect of the present invention, the laminated card assembly for use with a communication terminal includes a transaction card having a first engagement mechanism and being shaped into a standard SIM card; and a flexible SIM sheet, for performing communication operation for said communication terminal, having a second engagement mechanism to engage with said first engagement mechanism of said transaction card such that said flexible SIM sheet can be laminated on said transaction card to be inserted into a standard SIM socket of said communication terminal.

Certainly, the first engagement mechanism can be an opening and the second engagement mechanism can be a protrusion.

Preferably, the first engagement mechanism is a protrusion and the second engagement mechanism is an opening.

Preferably, the opening is provided with a plurality of flanges along periphery thereof, and the protrusion is provided with a plurality of notches to correspondingly engage with the plurality of flanges.

Preferably, the opening is provided with a plurality of notches along periphery thereof, and the protrusion is provided with a plurality of flanges to correspondingly engage with the plurality of notches.

Preferably, the opening is provided with a plurality of flanges along periphery thereof, and the protrusion is provided with a plurality of notches to correspondingly engage with the plurality of flanges.

Preferably, the opening is provided with a plurality of notches along periphery thereof, and the protrusion is provided with a plurality of flanges to correspondingly engage with the plurality of notches.

Preferably, the transaction card further comprises a first memory installed with an operation system for a credit card.

Certainly, the first memory can be a Read Only Memory (ROM).

Preferably, the transaction card further includes a second memory for storing applications associated with a fare applet of transportation, a loyalty applet of operator, a VIP management of membership, a mobile payment of bank, an e-ticket management of movie theater, and an e-coupon management of store.

Preferably, the second memory is an Electrically Erasable Programmable Read Only Memory (EEPROM).

Preferably, the laminated card assembly further includes an antenna coupled to the transaction card.

Preferably, the communication terminal is one of a mobile phone and a personal digital assistant.

Preferably, the transaction card is printed with a hologram thereon.

The above objects and advantages of the present invention will become more readily apparent to those ordinarily skilled in the art after reviewing the following detailed description and accompanying drawings, in which:

### BRIEF DESCRIPTION OF THE DRAWING

FIG. 1 illustrates one side of a transaction card according to the present invention;

FIG. 2 illustrates another side of a transaction card according to the present invention;

FIG. 3 illustrates one side of a flexible SIM sheet according to the present invention;

FIG. 4 illustrates another side of a flexible SIM sheet according to the present invention; and

FIG. 5 illustrates a preferred embodiment of a laminated card assembly with a detachable antenna according to the present invention.

### DETAILED DESCRIPTION OF THE PREFERRED EMBODIMENTS

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

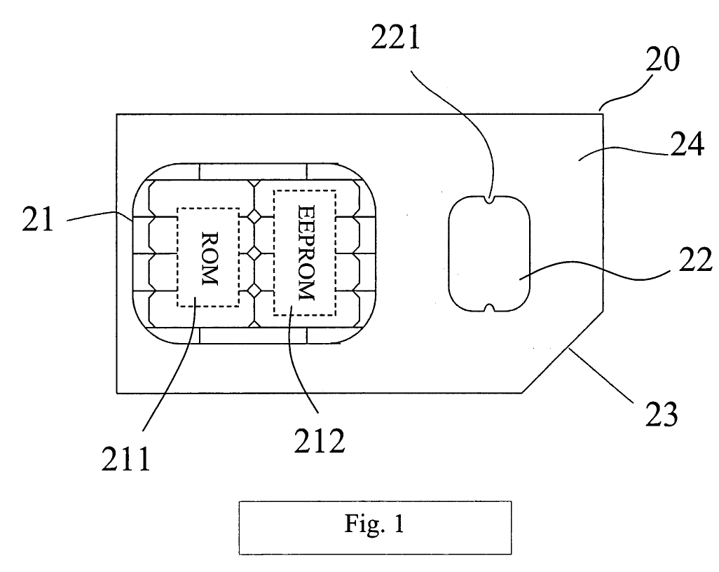

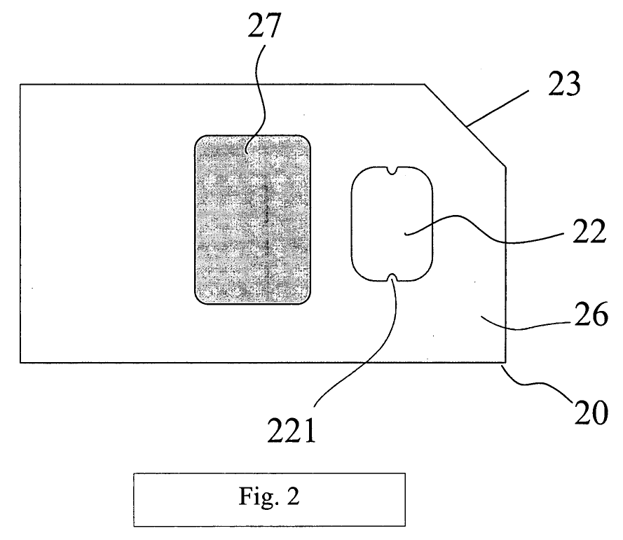

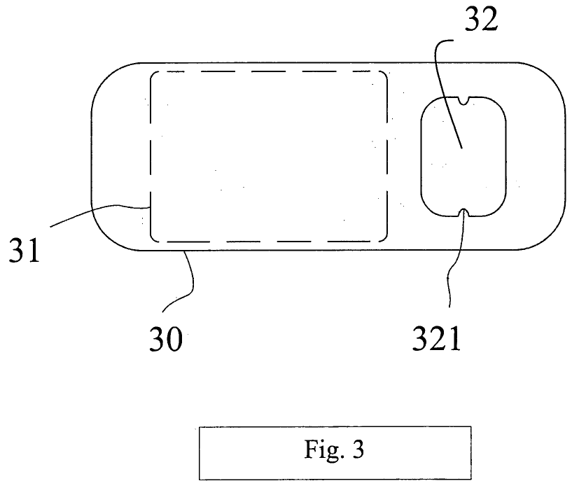

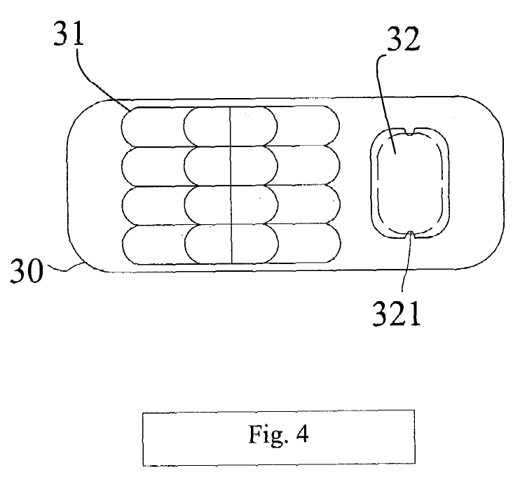

Please refer to FIGS. 1-4. Meanwhile, FIGS. 1-2 illustrate two sides of a transaction card according to the present invention, respectively; and FIGS. 3-4 illustrate two sides of a flexible SIM sheet according to the present invention, respectively. Accordingly, the laminated card assembly includes a transaction card 20 and a flexible SIM sheet 30. Meanwhile the transaction card 20, shown in FIGS. 1-2, includes a first engagement mechanism 22 and is shaped into a standard SIM card. Certainly, the transaction card 20 has a memory module 21 disposed on one surface 24 (as shown in FIG. 1) of the transaction card 20 to store related data and information. More particularly, the memory module 21 of the transaction card 20 further includes a first memory of a ROM 211 and a second memory of an EEPROM 212. The ROM 211 could include a credit card system. The EEPROM 212 could include applications associated with a fare applet of transportation, a loyalty applet of operator, a VIP management of membership, a mobile payment of bank, an e-ticket management of movie theater, and an e-coupon management of store. Therefore, the transaction card 20 could provide integrated functions of credit card and multi-application card.

In this embodiment, the transaction card 20 is a standard plug-in size, which is approximately 25 mm long and 15 mm wide, and less than 1 mm thick. Furthermore, to ensure correct orientation of the transaction card 20 upon insertion in the mobile phone, one corner of the otherwise rectangular card is cut to form a slope 23, so that the length of one edge of the card is reduced to about 21 mm while the width of the adjacent edge is reduced to about 12 mm. The card can only be inserted in the phone with an angled corner in the correct direction. A hologram 27 is formed on another surface 26 (as shown in FIG. 2) of the transaction card 20.

On the other hand, the laminated card assembly also includes a flexible SIM sheet 30, shown in FIGS. 3-4, for performing communication operation for the communication terminal. Meanwhile, the flexible SIM sheet 30 has a second engagement mechanism 32 to engage with said first engagement mechanism 22 of said transaction card such that said flexible SIM sheet 30 can be laminated on the transaction card 20 to be inserted into a standard SIM socket of the communication terminal. In this embodiment, the first engagement mechanism 22 can be an opening and the second engagement mechanism 32 can be a protrusion. The opening is provided with a plurality of flanges 221 along periphery thereof, and the protrusion is provided with a plurality of notches 321 to correspondingly engage with the plurality of flanges 221. Certainly, the first engagement mechanism of the present invention can be a protrusion and then the second engagement mechanism will be an opening. Either the opening is provided with a plurality of flanges along periphery thereof, and then the protrusion is relatively provided with a plurality of notches to correspondingly engage with the plurality of flanges; or the opening is provided with a plurality of notches along periphery thereof, and then the protrusion is relatively provided with a plurality of flanges to correspondingly engage with the plurality of notches.

In practice, the laminated card assembly could be applied for a portable device according to the present invention. In this embodiment, the portable device is a mobile phone or a personal digital assistant. Both of the transaction card 20 and the flexible SIM sheet 30 could be inserted together in the SIM sockets. In this embodiment, the laminated card assembly integrates functions of mobile phone (the flexible SIM sheet 30) and credit card (the transaction card 20).

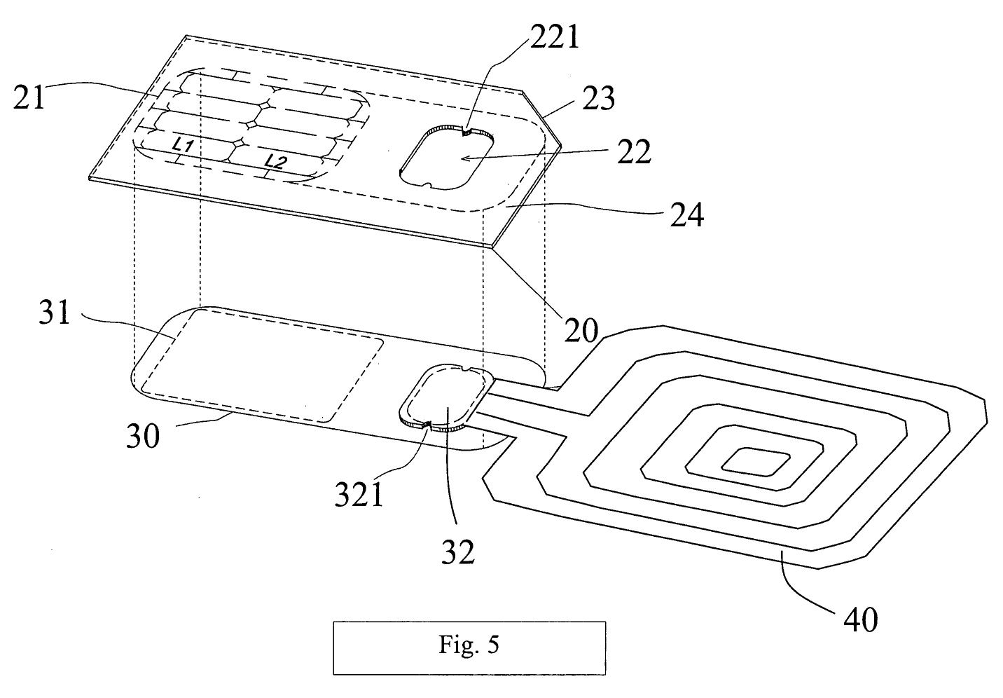

Please refer to FIG. 5. It further illustrates the relationship of the transaction card 20 and the flexible SIM sheet 30. According to FIGS. 1-5, the transaction card 20 has the memory module 21 mounted on or embedded into one surface 24 (as shown if FIG. 1) of the transaction card 20, and a cut slope 23 for guiding the user to insert the transaction card 20 in an appropriate direction. As known in the art, the cut slope 23 is for guiding insertion into a standard SIM card carrier or socket. In this embodiment, the transaction card 20 is in shape of a standard SIM card, but has a first memory of ROM 211 and a second memory of EEPROM 212 in the memory module 21, which is a credit card with multi-application card. Furthermore, a hologram 27 is formed on another surface 26 (as shown in FIG. 2) of the transaction card 20.

The substrate for the transaction card 20 may be made from a plastic material similar to those used for credit cards. Preferably, the material, in one example, the shape and dimension of the transaction card 20 is adapted to the standard SIM card applied in a mobile phone. The ROM 211 could include a credit card system; and the EEPROM 212 could include applications associated with a fare applet of transportation, a loyalty applet of operator, a VIP management of membership, a mobile payment of bank, an e-ticket management of movie theater, and an e-coupon management of merchant and store. Therefore, the transaction card 20 could provide functions of credit card and multi-application card. Meanwhile, the transaction card 20 could be printed with a hologram thereon.

Furthermore, the flexible SIM sheet 30 includes a SIM memory module 31 mounted on or embedded into one surface of the card 33. In this embodiment, the flexible SIM sheet 30 is thinner than the transaction card 20. When the flexible SIM sheet 30 and the transaction card 20 are engaged together, the entire thickness of both is almost the same as that of a standard SIM for mobile phone.

One feature of this embodiment is that the laminated card assembly further includes an antenna 40 coupled to the transaction card 20. As shown in FIG. 5, a part of the antenna 40 is clipped between the transaction card 20 and the flexible SIM sheet 30 while the second engagement mechanism 32 and the first engagement mechanism 22 are engaged with each other. Furthermore, the antenna 40 has two terminals (not shown) conducted electricity with contact L1 and contact L2 of the memory module 21 of the transaction card 20 respectively to couple the antenna 40 with the transaction card 20 for communication with an external transaction device. In practice, the antenna 40 can be flexible. Due to the ability of the memory module 21 to communicate with an external transaction device, such as a credit card reader, via the transmission/reception of electrical signals through the air using a RF module of the portable communication device, the service provider may identify the user code or the device code in the transaction card 20. In this manner, the service provider may determine the communication parameters of the transaction card 20. The transaction card 20 transmits and receives information in the form of electrical signal through the transaction device. In this embodiment, the antenna 40 is coupled to the transaction card 20 for near field communication (contactless applications). The transaction card 20 communicates with the transaction device via the transmission/reception of electrical signals through the ambient air using the antenna 40. It should be noted that the antenna 40 is different from the antenna of the portable communication device. It is a low power consumption antenna for contactless or Near Field Communication (NFC). Contactless transaction provides advantages over contact-type cards, such as faster transaction times and ease of use.

The transfer or reading of information to or from the transaction device for contactless transaction via the transaction card 20 is achieved by sending RF signals through the antenna 40. When the user brings the transaction card 20 with the function of contactless transaction close to a card reader within a range, the reader is enabled to read the identification data contained in the memory module 21 via the antenna 40. When a contactless transaction is used in a transportation system, the memory module 21 mounted in the card contains the user's account information or billing information. The user may access or update the user's account. The transaction card 20 and the flexible SIM sheet 30 may be detachable from the socket of the portable device as known in the art. The flexible SIM sheet 30 and the transaction card 20 may be formed of a plastic material and be combined as a standard size of SIM card to insert into a card socket of a mobile phone. Antenna 40 can be provided as a length of a filament or wire, which may be formed by printing. Additionally, a radio frequency identification (RFID) technology could be introduced into the second engagement mechanism 32 of the flexible SIM sheet or the memory module 21 of the transaction card 20. Usually, the RFID system consists of an antenna, transceiver (often combined into one reader) and a transponder (i.e. tag). The antenna uses radio frequency waves to transmit a signal that activates the transponder. When activated, the tag transmits data back to the antenna. The data is used to notify a programmable logic controller that an action should occur. The action could be as simple as raising an access gate or as complicated as interfacing with a database to carry out a monetary transaction. Meanwhile, the antenna of RFIC module could be introduced into the second engagement mechanism 32 of the flexible SIM sheet, the memory module 21 of the transaction card 20 or both of them. Therefore, the laminated card assembly of the present invention provides additional service, which does not require direct contact or scanning.

In conclusion, the present invention provides a laminated card assembly for use with a communication terminal, which is capable of serving a payment function by means of contactless transaction and which is of a size that is easily and conveniently stored in a mobile phone. More particularly, the transaction card of the present invention further includes a ROM and an EEPROM for storing information of a credit card system, and information of a multi-application card system, such as a fare applet of transportation, a loyalty applet of operator, a VIP management of membership, a mobile payment of bank, an e-ticket management of movie theater, or an e-coupon management of merchant and store. Therefore, the laminated card assembly of the present invention could provide further functions of credit card and multi-application card, but the prior art fail to disclose that.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. A laminated card assembly for use with a communication terminal, comprising:
a transaction card having a first engagement mechanism and being shaped into a standard SIM card; and
a flexible SIM sheet, for performing communication operation for said communication terminal, having a second engagement mechanism to engage with said first engagement mechanism of said transaction card such that said flexible SIM sheet can be laminated on said transaction card to be inserted into a standard SIM socket of said communication terminal.

2. The laminated card assembly according to claim 1, wherein said first engagement mechanism is an opening and said second engagement mechanism is a protrusion.

3. The laminated card assembly according to claim 2, wherein said opening is provided with a plurality of flanges along periphery thereof, and said protrusion is provided with a plurality of notches to correspondingly engage with said plurality of flanges.

4. The laminated card assembly according to claim 2, wherein said opening is provided with a plurality of notches along periphery thereof, and said protrusion is provided with a plurality of flanges to correspondingly engage with said plurality of notches.

5. The laminated card assembly according to claim 1, wherein said first engagement mechanism is a protrusion and said second engagement mechanism is an opening.

6. The laminated card assembly according to claim 5, wherein said opening is provided with a plurality of flanges along periphery thereof, and said protrusion is provided with a plurality of notches to correspondingly engage with said plurality of flanges.

7. The laminated card assembly according to claim 5, wherein said opening is provided with a plurality of notches along periphery thereof, and said protrusion is provided with a plurality of flanges to correspondingly engage with said plurality of notches.

8. The laminated card assembly according to claim 1, wherein said transaction card further comprises a first memory installed with an operation system for a credit card.

9. The laminated card assembly according to claim 8, wherein said first memory is a Read Only Memory (ROM).

10. The laminated card assembly according to claim 1, wherein said transaction card further comprises a second memory for storing applications associated with a fare applet of transportation, a loyalty applet of operator, a VIP management of membership, a mobile payment of bank, an e-ticket management of movie theater, and an e-coupon management of store.

11. The laminated card assembly according to claim 10, wherein said second memory is an Electrically Erasable Programmable Read Only Memory (EEPROM).

12. The laminated card assembly according to claim 1, further comprising an antenna coupled to said transaction card.

13. The laminated card assembly according to claim 1, wherein said communication terminal is one of a mobile phone and a personal digital assistant.

14. The laminated card assembly according to claim 1, wherein said transaction card is printed with a hologram thereon.
